(19) United States
(12) Patent Application Publication
(10) Pub. No.: US 2026/0171499 A1
(43) Pub. Date: Jun. 18, 2026

(54) ELECTROLYTE FOR LITHIUM METAL BATTERY AND LITHIUM METAL BATTERY INCLUDING THE SAME

(71) Applicants: HYUNDAI MOTOR COMPANY, SEOUL (KR); KIA CORPORATION, SEOUL (KR)

(72) Inventors: Yeonjong Oh, Hwaseong-si (KR); Ji Yong Lee, Hwaseong-si (KR); Won Keun Kim, Hwaseong-si (KR); Eunji Kwon, Hwaseong-si (KR); Kyuju Kwak, Hwaseong-si (KR); Jiho Lim, Hwaseong-si (KR); Dong Hyun Lee, Hwaseong-si (KR); Sangsu Lee, Hwaseong-si (KR); Kyoung Han Ryu, Hwaseong-si (KR); Samuel Seo, Hwaseong-si (KR)

(73) Assignees: HYUNDAI MOTOR COMPANY, SEOUL (KR); KIA CORPORATION, SEOUL (KR)

(21) Appl. No.: 19/402,288

(22) Filed: Nov. 26, 2025

(30) Foreign Application Priority Data
Dec. 16, 2024 (KR) 10-2024-0187312

(51) Int. Cl. H01M 10/0567; H01M 10/052; H01M 10/0568; H01M 10/0569

(52) U.S. Cl. CPC H01M 10/0567; H01M 10/052; H01M 10/0568; H01M 10/0569; H01M 2300/0042

(57) ABSTRACT

An electrolyte for a lithium metal battery includes a lithium salt, a non-aqueous organic solvent, and a nitrate additive, wherein the lithium salt is different from the nitrate additive, the lithium salt is included in an amount of greater than or equal to 15 mol % based on a total amount (100 mol %) of the electrolyte for the lithium metal battery, and the nitrate additive is included in an amount of greater than or equal to 3 mol % based on a total amount (100 mol %) of the electrolyte for the lithium metal battery.

### CROSS-REFERENCE TO RELATED APPLICATION

This application claims priority to and the benefit of Korean Patent Application No. 10-2024-0187312 filed with the Korean Intellectual Property Office on Dec. 16, 2024, the entire contents of which are incorporated herein by reference.

### FIELD

The present invention relates to an electrolyte for a lithium metal battery and a lithium metal battery including the same.

### BACKGROUND

As the electric vehicle market grows, there is an increasing need for high-capacity batteries that improve on and surpass lithium ion batteries. This results in an increasing demand for negative and positive electrode materials with high energy density that can provide for high energy density and long-term stability of the lithium metal batteries.

Lithium metal, which has high capacity per weight of 3,860 mAh/g and a low standard electrode potential (−3.04 V vs normal hydrogen electrode), is a desirable negative electrode material for lithium secondary batteries. However, lithium metal is highly reactive, creating an extremely reducing atmosphere during the charging process, which may cause an irreversible decomposition reaction between the lithium metal and an electrolyte. The decomposition reaction may deplete the electrolyte, and the decomposition reaction products may form a nonuniform film on the lithium metal surface. In addition, lithium can form dendrites, as charging and discharging cycles are repeated. The dendritic lithium causes electrical short circuits inside the batteries, leading to safety issues such as battery fires, leaks, explosions, and the like.

Therefore, one strategy to realize the application of lithium metal with high stability and high capacity, relates to the development of an electrolyte that alleviates (e.g., reduces, controls, etc.) reactivity of lithium metal, prevents dendritic lithium growth, and/or enables uniform lithium electrodeposition (plating).

### SUMMARY

In an aspect, to the disclosure provide an electrolyte for a lithium metal battery capable of inducing uniform electrodeposition and desorption of lithium ions through forming a thin film on a current collector and/or a lithium metal surface.

In an embodiment, the disclosure provides a lithium metal battery capable of delaying the depletion point of a lithium salt and can exhibitexcellent durability performance.

An electrolyte for a lithium metal battery according to an embodiment comprises a lithium salt; a non-aqueous organic solvent; and a nitrate additive distinct from the lithium salt; the lithium salt is included in an amount of greater than or equal to 15 mol % based on a total amount (100 mol %) of the electrolyte for the lithium metal battery, and the nitrate additive is included in an amount of greater than or equal to 3 mol % based on a total amount (100 mol %) of the electrolyte for the lithium metal battery.

In embodiments, the lithium metal battery may be a lithium iron phosphate battery.

In embodiments, the electrolyte for the lithium metal battery may include, based on a total amount (100 mol %) of the electrolyte for the lithium metal battery, 15 mol % to 30 mol % of the lithium salt; 3 mol % to 10 mol % of the nitrate additive; and with a balance amount of the mol % comprising a non-aqueous organic solvent.

In embodiments, the non-aqueous organic solvent may be included in an amount of 60 mol % to 80 mol % based on a total amount (100 mol %) of the electrolyte for the lithium metal battery.

In embodiments, the non-aqueous organic solvent may include the non-limiting examples of dipropyl ether, diethyl ether, 1,2-dimethoxyethane, 1,2-diethoxyethane, cyclopentyl methyl ether, methyl propyl ether, n-butyl methyl ether, ethyl propyl ether, dimethoxymethane, 1,4-dioxane, 1,2,2-tetrafluoroethyl-2,2,3,3-tetrafluoropropyl ether, or a combination thereof.

In embodiments, the lithium salt may include at least one selected from lithium bis(fluorosulfonyl)imide (LiFSI), lithium (fluorosulfonyl) (nonafluorobutanesulfonyl)imide (LiFNFSI), lithium bis(perfluoroethylsulfonyl)imide (LiBETI), and lithium bis(trifluoromethanesulfonyl)imide (LiTFSI).

In embodiments, the nitrate additive may include LiNO₃.

According to another aspect, the present invention provides a lithium metal battery comprising a positive electrode; a lithium metal layer as a negative electrode facing the positive electrode; a separator interposed between the positive electrode and the negative electrode; and the electrolyte for the lithium metal battery in accordance with the aspects and embodiments of the disclosure.

In embodiments, the lithium metal layer may have a thickness of 5 μm to 200 μm. In embodiments, the positive electrode may include lithium iron phosphate.

In embodiments, the electrolyte for the lithium metal battery according to the disclosure has the effect of improving the durability performance of a lithium metal battery, and in some specific embodiments, a lithium iron phosphate lithium metal battery.

### BRIEF DESCRIPTION OF THE DRAWINGS

FIG. 1 shows the results of durability performance evaluation in Li/LFP coin cells (1/3C) using each electrolyte according to Example 1, Comparative Example 3, and Comparative Example 4.

FIG. 2 shows the results of efficiency evaluation after 60 cycles in Li/LFP coin cells (1/3C) using each electrolyte according to Example 1, Comparative Example 3, and Comparative Example 4.

FIG. 3 shows the results of durability performance evaluation in Li/LFP coin cells (1/3C) using each electrolyte according to Comparative Examples 1 to 4.

FIG. 4 shows the results of durability performance evaluation in Li/LFP coin cells (1/3C) using each electrolyte according to Example 1, Comparative Example 5, and Comparative Example 6.

FIG. 5 shows the results of durability performance evaluation in Li/LFP coin cells (1/3C) using each electrolyte according to Example 1, Comparative Example 3, and Comparative Example 4.

FIG. 6A to 6C show the results of analyzing the lithium negative electrode electrodeposition phenomenon after driving (5 cycles) Li/LFP coin cells using each electrolyte according to Example 1, Comparative Example 3, and Comparative Example 4.

FIG. 7A shows the viscosity (25° C.) of the electrolytes according to Example 1 and Comparative Example 3.

FIG. 7B shows the ionic conductivity (25° C.) of the electrolytes according to Example 1 and Comparative Example 3.

### DETAILED DESCRIPTION

The above and other objects, features and advantages of the present disclosure will be more clearly understood from the following aspects and embodiments taken in conjunction with the accompanying drawings. However, neither the present disclosure nor the claims are limited to the embodiments disclosed herein, and may be modified into different forms in accordance with the guidance provided herein. The example aspects and embodiments are provided herein in an effort to thoroughly explain the various features of the disclosure and to convey the spirit of the present disclosure to those skilled in the art.

Throughout the drawings, the same reference numerals will refer to the same or like elements. For the sake of clarity of the present disclosure, the dimensions of structures are depicted as being larger than the actual sizes thereof. It will be understood that, although terms such as “first”, “second”, etc. may be used herein to describe various elements, these elements are not to be limited by these terms. These terms are only used to distinguish one element from another element. For instance, a “first” element discussed below could be termed a “second” element without departing from the scope of the present disclosure. Similarly, the “second” element could also be termed a “first” element. As used herein, the singular forms are intended to include the plural forms as well, unless the context clearly indicates otherwise.

It will be further understood that the terms “comprise” or “comprising”, “include” or “including”, “have” or “having”, etc., when used in this specification, specify the presence of stated features, integers, steps, operations, elements, components, or combinations thereof, but do not preclude the presence or addition of one or more other features, integers, steps, operations, elements, components, or combinations thereof. In some aspects and embodiments, these terms should be understood to encompass the terms “consisting of” and “consisting essentially of” which refer to features, integers, numbers, steps, operations, elements, components, parts, or combinations thereof that only include the recited components, or the recited components allowing for minor amounts of other components or elements that do not have a material effect on the function of the recited feature, component, embodiment, or aspect of the disclosure. Thus, some aspects and embodiments may refer to these various transitionary terms, all of which form part of the disclosure.

Also, it will be understood that when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

In the present specification, when a range is described for a variable, it will be understood that the variable includes all values including the end points described within the stated range. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

Furthermore, unless specifically stated otherwise, the term “about” as used or implied herein may be understood within a range of error that is typical in the art (e.g., within 2 standard deviations of the mean). “About” may be understood as within 10%, 9%, 8%, 7%, 6%, 5%, 4%, 3%, 2%, 1%, 0.5%, 0.1%, 0.05%, or 0.01% of the stated value.

### <Electrolyte for Lithium Metal Battery>

As noted above, development of an organic electrolyte for a lithium iron phosphate battery has technological challenges such as lithium growth in the form of dendrite in a negative electrode during the charge, continuous oxidation-reduction decomposition reaction between electrolyte and electrode, and irreversible lithium generated during the charge/discharge, which cause cell deterioration leading to reducing discharge capacity and, ultimately, cell termination. To overcome these problems, the disclosure provides an additive for forming a stable film on the lithium metal. In embodiments, and as discussed demonstrated herein lithium nitrate (LiNO₃), in particular finds use as an additive for stabilizing lithium metal among the various additives, and is particularly suitable for stabilizing lithium metal used as a negative electrode in a lithium iron phosphate lithium metal battery. Some non-limiting embodiments demonstrate that lithium nitrate can stabilize the lithium negative electrode film, maximize electrodeposition-desorption reversibility of the lithium, and improve durability performance of the lithium iron phosphate lithium metal battery.

When operating a battery having lithium as a negative electrode, however, only small amounts of the additive can be included (e.g., about 1 to 2 wt % based on a total amount of an electrolyte), which can limit the degree to which the additive can induce stable electrodeposition-desorption of the lithium. For example, if an excess amount of the additive is included (i.e., dissolved) in the electrolyte, a film (SEI Layer) may be formed having an excessive thickness and in an excessive amount, which induces resistance to the movement of lithium ions, and an uneven (i.e., non-uniform) lithium electrodeposition, which can cause premature deterioration of the battery. Accordingly, the amount of the additive should be included in controlled amounts in order to suppress undesirable side reactions. This also puts a clear limitation on the potential improvement that the lithium nitrate can have on forming a stable film on the lithium metal.

Accordingly, in light of the recognized limitations in the state of the art, the inventors developed an electrolyte composition that can maximize utilization of the lithium nitrate additive in a lithium iron phosphate battery. In accordance with various embodiments of the disclosure, an electrolyte composition containing an excess amount of lithium nitrate additive is provided. The novel electrolyte composition improves durability and electrochemical characteristics relative to a conventional battery, which distinguishes the electrolyte composition, and batteries comprising the same from from those in conventional use.

In a general sense, the present invention relates to a novel electrolyte composition that can improve the durability and electrochemical characteristics of a lithium iron phosphate battery. In some specific embodiments, the disclosure provides an electrolyte composition comprising two types of lithium salts, and each of which are included in excess amounts.

An electrolyte for a lithium metal battery according to an embodiment may include a lithium salt; a non-aqueous organic solvent; and a nitrate additive. In embodiments, the nitrate additive is different from the lithium salt. And, unlike the the electrolyte composition in a conventional lithium iron phosphate lithium metal battery, the electrolyte composition in accordance with the disclosure includes both the lithium salt and the nitrate additive in an excess, which can improve the durability performance of the lithium iron phosphate lithium metal battery.

In embodiments, the lithium salt may be included in an amount of greater than or equal to 15 mol % based on a total amount (100 mol %) of the electrolyte for the lithium metal battery, and the nitrate additive may be included in an amount of greater than or equal to 3 mol % based on a total amount (100 mol %) of the electrolyte for the lithium metal battery. In embodiments wherein the lithium salt and a (chemically different) nitrate additive are each included in the above ranges to form an electrolyte, the viscosity of the electrolyte at room temperature (25° C.) decreases and, at the same time, the ionic conductivity of the electrolyte at room temperature (25° C.) increases. These features provide for output characteristics of a lithium metal battery manufactured using the electrolyte, and in some specific embodiments, a lithium iron phosphate lithium metal battery, to be appreciably improved, and ultimately, can achieve excellent durability performance. In embodiments, wherein the nitrate additive is included in an excess amount of greater than or equal to 3 mol % based on the total amount of the electrolyte for the lithium metal battery, the stability of the lithium metal can be improved, and both a uniform electrodeposition and lower a electrodeposition of lithium can be induced, which can result in formation of a useful SEI film. Disadvantages can arise when amounts of the components are not controlled, in that the precipitation of the lithium salt and the additive can occur, and/or the SEI interface becomes too thick, which reduces lithium ion movement and increases battery resistance. Thus, in the electrolyte according to the aspects and embodiments of the disclosure, the amount of (i) the nitrate additive, (ii) the lithium salt, and (iii) the type and amount of the non-aqueous organic solvent (e.g., as described herein) are suitably controlled together to provide a lithium metal battery comprising either or both of improved durability and/or electrochemical characteristics. In some specific embodiments, the battery comprises a lithium iron phosphate lithium metal battery. Accordingly, the disclosure provides advantages relative to electrolytes, and methods for generating the same, that focus on a strategy that merely includes nitrate as an additive in a limited amount, in that such strategies make it very difficult to simultaneously improve the durability and electrochemical characteristics of lithium metal batteries (e.g., iron phosphate lithium metal batteries).

In some example embodiments, the lithium metal battery may be a lithium iron phosphate lithium metal battery that uses lithium iron phosphate as a positive electrode and lithium metal as a negative electrode.

In some example embodiments, the electrolyte for the lithium metal battery may include, based on a total amount (100 mol %) of the electrolyte for the lithium metal battery, 15 mol % to 30 mol % of the lithium salt; 3 mol % to 10 mol % of the nitrate additive; and a balance amount (to 100 mol %) of the non-aqueous organic solvent.

In some example embodiments, the non-aqueous organic solvent may be included in an amount of 60 mol % to 80 mol % based on a total amount (100 mol %) of the electrolyte for the lithium metal battery.

In embodiments wherein the composition of the electrolyte for the lithium metal battery is maintained within the ranges described above, the durability performance of the lithium metal battery including the electrolyte, as well as a lithium metal battery (e.g., a lithium iron phosphate lithium metal battery), may be significantly improved or maximized.

In some embodiments, the non-aqueous organic solvent may comprise an ether-based non-aqueous organic solvent. In embodiments wherein the ether-based non-aqueous organic solvent is included in amounts within the aforementioned composition, the durability performance of lithium metal batteries can be improved significantly, in particular when compared to electrolytes include other types and amounts of non-aqueous organic solvents. In some non-limiting example embodiments, the non-aqueous organic solvent may include dipropyl ether, diethyl ether, 1,2-dimethoxyethane, 1,2-diethoxyethane, cyclopentyl methyl ether, methyl propyl ether, n-butyl methyl ether, ethyl propyl ether, dimethoxymethane, 1,4-dioxane, 1,2,2-tetrafluoroethyl-2,2,3,3-tetrafluoropropyl ether, or a combination thereof.

According to an embodiment, the lithium salt may include at least one of lithium bis(fluorosulfonyl)imide (LiFSI), lithium (fluorosulfonyl) (nonafluorobutanesulfonyl)imide (LiFNFSI), lithium bis(perfluoroethylsulfonyl)imide (LiBETI), and lithium bis(trifluoromethanesulfonyl)imide (LiTFSI). In some specific embodiments, the lithium salt may be LiFSI.

The concentration of the lithium salt included in the electrolyte for the lithium metal battery according to some embodiments may range from 1.0 M to 4.5 M. In some specific embodiments, the concentration may range from, for example, 1.5 M to 4.0 M, 1.6 M to 3.9 M, 1.7 M to 3.8 M, 1.8 M to 3.7 M, or 1.9 M to 3.6 M.

Without being limited by any particular mechanism, the inventors observe that when the concentration of the lithium salt is below the above range, the conductivity of the electrolyte may decrease, which may result in poor electrolyte performance. And, similarly, if the concentration of the lithium salt exceeds the above range, the viscosity of the electrolyte may increase, which may result in reduced mobility of lithium ions and a problem of overvoltage occurring from the beginning of the cycle. In some embodiments, an SEI layer of suitable thickness may formed on the surface of the lithium metal (i.e., which is the negative electrode). That is, if an SEI film/layer is not formed at all, or too thick of an SEI film/layer is formed, the resulting lithium metal battery may have impaired (i.e., lower) electrochemical performance.

In embodiments, the nitrate additive may include LiNO₃. In embodiments wherein the nitrate additive in the above electrolyte includes LiNO₃, the compatibility between the additive and the aforementioned types of lithium salt and ether-based non-aqueous organic solvent can be maximized, or even synergistic, providing for substantial improvement in the lithium metal battery cycle performance and durability characteristics.

### <Lithium Metal Battery>

In another aspect, the disclosure provides a lithium metal battery including the electrolyte for the lithium metal battery in accordance with the aspects and embodiments as described above.

In embodiments, the lithium metal battery may include a positive electrode, a lithium metal layer as a negative electrode facing the positive electrode, a separator interposed between the positive electrode, and the negative electrode and the electrolyte (e.g., as disclosed herein).

In embodiments, the negative electrode for a lithium metal battery may comprise a lithium metal layer, and the lithium metal layer itself may be used (i.e., function/operate) as a negative electrode for a battery.

In embodiments, a battery including the negative electrode may allow lithium ions from the positive electrode to move to the negative electrode to form a lithium metal layer when charged. Charging and discharging of the battery may be proceeded by forming, or removing, this lithium metal layer.

In embodiments the negative electrode may be formed on a negative electrode current collector such as copper, for example.

In embodiments, the lithium metal layer may have a thickness of 5 μm to 200 μm, such as, for example, 10 μm to 200 μm, or may be formed to have a thickness within this range.

In embodiments wherein the lithium metal layer falls within the above thickness ranges, any side reactions between the lithium metal layer and the electrolyte may be suppressed, which can thereby improve the electrochemical performance of the lithium metal battery.

In another embodiment, the positive electrode is disposed opposite the negative electrode (e.g., the faces of the positive electrode and the negative electrode may be positioned or oriented to oppose each other).

In embodiments, the positive electrode may include a positive electrode current collector and a positive electrode active material layer formed on the positive electrode current collector.

In embodiments, the positive electrode collector may be made of stainless steel, aluminum, nickel, titanium, calcined carbon, or aluminum or stainless steel surface-treated with carbon, nickel, titanium, silver, and the like.

In embodiments, the thickness of the positive electrode collector may be within a range of 3 μm to 500 μm.

In embodiments, the positive electrode active material layer includes a positive electrode active material.

In embodiments, the positive electrode active material may comprise a compound capable of reversibly intercalating and deintercalating lithium. In some specific embodiments, the positive electrode active material may include lithium iron phosphate. In embodiments wherein the positive electrode active material includes lithium iron phosphate, the compatibility of the components (e.g., the positive electrode active material and the electrolyte) may be particularly good, such that the improvement in battery performance may be particularly substantial or maximized.

In embodiments, the positive electrode active material layer may further include a binder and/or a conductive material.

In embodiments, the separator provides a physical barrier (e.g., separates) between the negative electrode and the positive electrode, while allowing for passage of lithium ions (e.g., flowpaths for lithium ion movement). The separator itself is not particularly limited as long as it functions as described, and as such, can comprise any one or more separator(s) that finds common use in lithium secondary batteries.

The following examples illustrate particular aspects and embodiments of the present disclosure in more detail. However, the following examples are provided only for purposes of additional clarity and illustration of some embodiments of the present invention, and do not limit the scope of the disclosure or the appended claims.

### (Example) Preparation of Electrolyte for Lithium Metal Battery

An amount of LiFSI salt was added to 1,2-diethoxyethane solvent and mixed to form a transparent solution. To the solution, LiNO₃ was added in particular amounts and mixed to form a transparent solution and providing an electrolyte composition for analysis and use in a lithium metal battery.

Table 1 shows the composition of electrolytes for lithium metal battery cells according to Examples and Comparative Examples.

TABLE 1

| | | | Amount of 1,2- |
|---|---|---|---|
| | Amount of LiFSI | Amount of LiNO₃ | diethoxyethane |
| Example 1 | 1 mole (23.6%) | 0.24 mole (5.7%) | 3 moles (70.7%) |
| Comparative | 1 mole (12.5%) | — | 7 moles (87.5%) |
| Example 1 | | | |
| Comparative | 1 mole (12.4%) | 0.07 mole (0.9%) | 7 moles (86.7%) |
| Example 2 | | | |
| Comparative | 1 mole (12.3%) | 0.14 mole (1.8%) | 7 moles (85.9%) |
| Example 3 | | | |
| Comparative | 1 mole (11.8%) | 0.45 mole (5.4%) | 7 moles (82.8%) |
| Example 4 | | | |
| Comparative | 1 mole (23.6%) | — | 3 moles (70.7%) |
| Example 5 | | | |
| Comparative | 1 mole (24.8%) | 0.04 mole (1.0%) | 3 moles (74.3%) |
| Example 6 | | | |

Evaluation Example: Durability and Electrochemical Characteristics of Lithium Iron Phosphate Lithium Metal Battery Cell

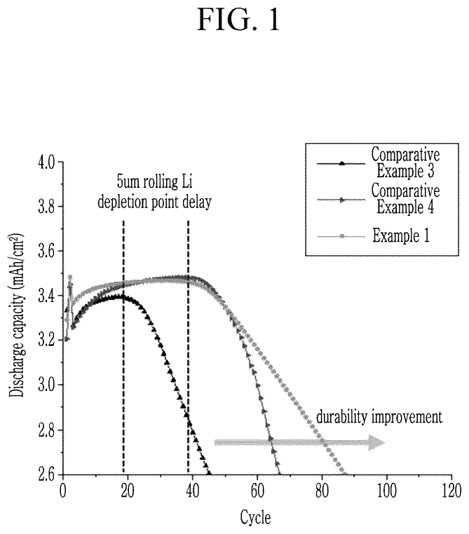

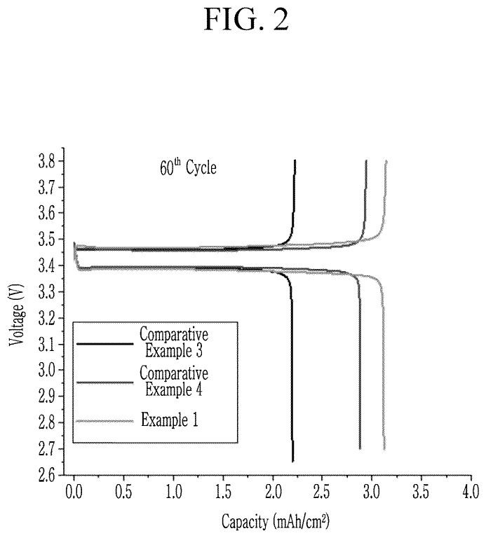

(1) To evaluate durability and electrochemical characteristics, a lithium iron phosphate battery cell was manufactured by using a lithium thin film (5 μm-thick) as a negative electrode and LFP (lithium iron phosphate) as a positive electrode, with the results shown in Table 2 and FIG. 1.

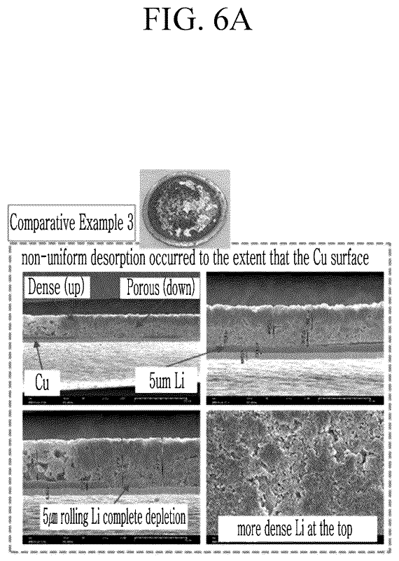

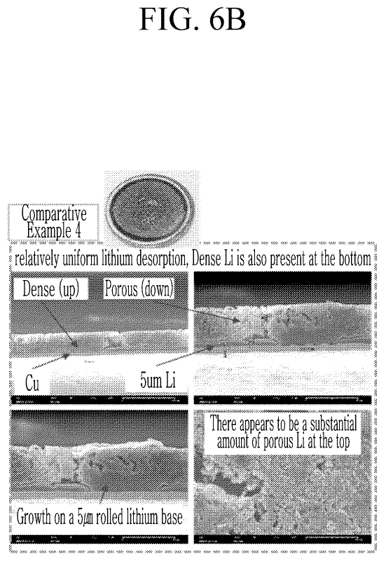

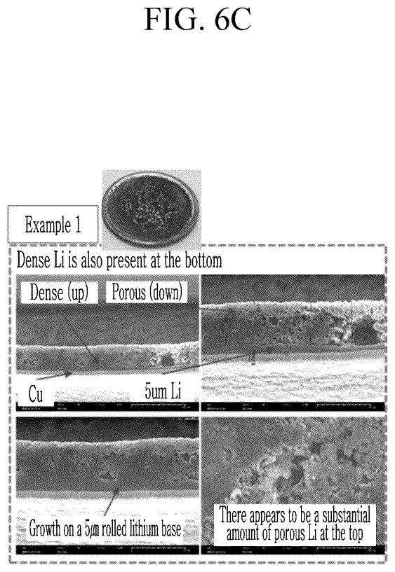

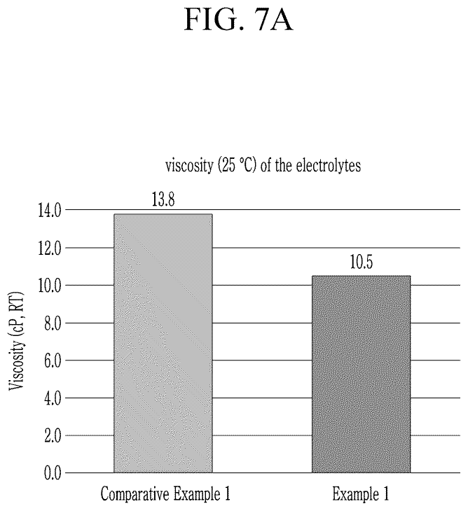

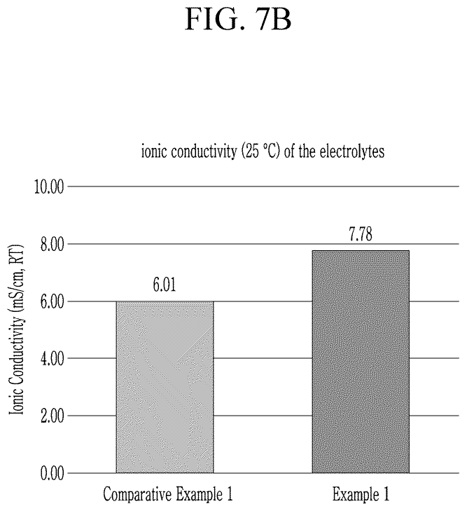

The electrolyte compositions of Example 1 and Comparative Example 3 were subjected to additional analysis by measuring viscosity and ionic conductivity at room temperature (25° C.), with the results shown in Table 2 and FIGS. 6A and 6B.

TABLE 2

| | Li (5 μm)-LFP | | |
|---|---|---|---|
| | durability (discharge | Viscosity | Ionic conductivity |
| | capacity Ret. 70%) | (Cp @ 25° C.) | (mS/cm @ 25° C.) |
| Example 1 | 98th | 10.5 | 7.78 |
| Comparative | 67th | 13.8 | 6.01 |
| Example 3 | | | |

Referring to FIG. 1 and Table 2, the electrolyte of Example 1 was observed to have improved durability, improved by 46 times (i.e., from 67 times to 98 times) under the cell evaluation conditions using thin film lithium as a negative electrode. Notably, the electrolyte of Example 1 when compared to that of Comparative Example 3, exhibited a delay in consumption of the thin film lithium, e.g., by 20 times or more, thereby reducing non-uniform lithium electrodeposition-desorption and any lithium side-reaction(s), all indicating an increase in lithium stability and lithium flow reversibility (relative to the Comparative Example). In addition, the electrolyte of Example 1, compared to that of Comparative Example 3, exhibited about reduced viscosity (˜24%). The reduced viscosity may provide an improvement in the wettability of the positive electrode, which is advantageous when applying a high-loading electrode and post-injection process. Further, improvement in processibility was achieved in the pilot step, and ionic conductivity was increased by 29%. The data demonstrates that output characteristics of a lithium iron phosphate battery may be improved by incorporating an electrolyte composition in accordance with the example embodiments of the disclosure, and as illustrated by this comparative embodiment.

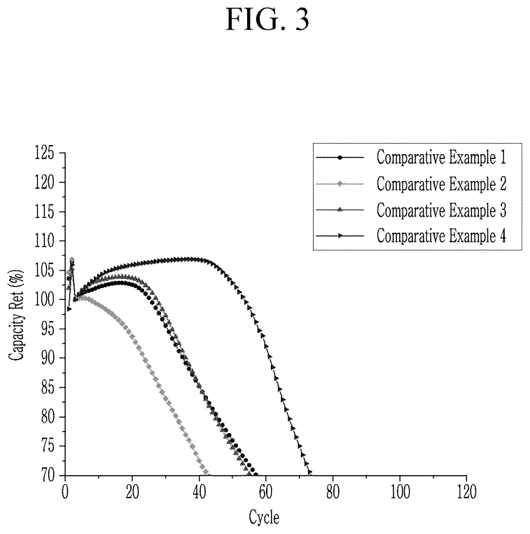

(2) A small amount of lithium nitrate (LiNO₃) additive was added to generate SEI (e.g., Li₃N) which functioned to stabilize the lithium negative electrode. To determine an amount of LiNO₃ (e.g., how much in excess) that is effective to improve the durability of a lithium iron phosphate battery, LiNO₃ was added to the electrolyte in increasing amounts from 0.07 to 0.45 mole (with a lithium salt (LiFSI) at a constant low concentration, (e.g., Comparative Examples 1 to 4)) to manufacture lithium iron phosphate battery cells. Durability of lithium iron phosphate battery cells were evaluated with the results shown in FIG. 3.

Referring to FIG. 3, the data indicates that the lithium iron phosphate battery cells having the best cycle-life, in rank order, were Comparative Examples 1 to 4, which correlates to higher/increasing added amounts of the lithium nitrate.

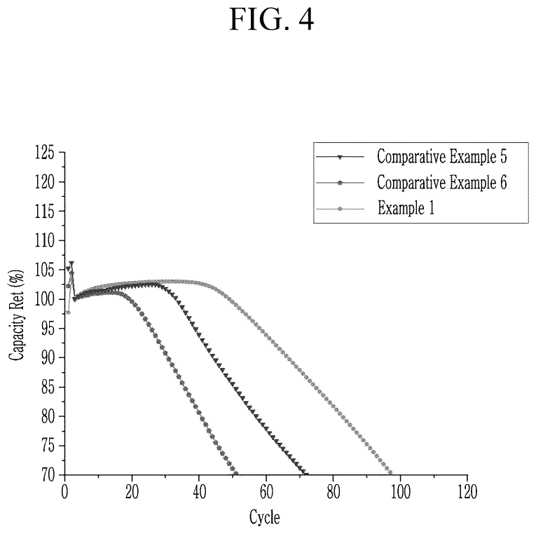

(3) The above electrochemical evaluation of the lithium iron phosphate battery cells (as a function of amount of lithium nitrate at low LiFSI concentration), indicated that adding a larger amount lithium nitrate amount appears to correlate with greater improvement in durability. To supplement that data, the durability of the lithium iron phosphate battery cells was also evaluated at a high concentration of LiFSI, with the results shown in FIG. 4.

Referring to FIG. 4, the data indicates that the lithium iron phosphate battery cells exhibited a better cycle-life with greater amounts of lithium nitrate, i.e., in the order of Comparative Example 5, Comparative Example 6, and Example 1. However, when the lithium nitrate amount was greater than 10 mol %, based on a total amount (100 mol %) of the electrolyte, the lithium nitrate precipitated. From that observation, the amount of lithium nitrate may be advantageously maintained in a range of less than or equal to 10 mol % based on the total amount (100 mol %) of the electrolyte.

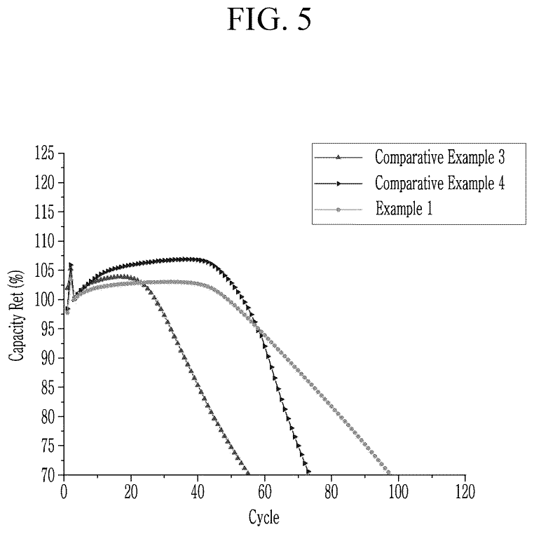

(4) Comparative Examples 3 and 4 and Example 1 were evaluated to determine the effect that addition of excess amounts of lithium nitrate has on durability, with the results shown in FIG. 5.

Referring to FIG. 5, a comparison of Comparative Examples 3 and 4 suggests that in an environment of constant (or similar) low lithium salt concentrations, the degree of improvement in durability increases with higher amounts of added nitrate. The data for Comparative Example 4 and Example 1, indicates that greater durability is observed in an excess nitrate environment of with a higher lithium salt ratio and a lower solvent ratio. The data demonstrates that an electrolyte having the same components can exhibit significantly different improvements in durability depending on the amounts of the components in the electrolyte composition, confirming that electrolyte composition is a sensitive factor in determining durability and any relative improvement in durability.

(5) The electrolyte composition of Example 1 was used to manufacture lithium iron phosphate battery cells as in (1), above, and operated to analyze lithium negative electrode electrodeposition morphologies, with the results shown in FIGS. 6A to 6C.

Referring to FIGS. 6A to 6C, Comparative Example 3 exhibited non-uniform desorption as the Cu surface of the 5 μm thin film Li was exposed. In contrast, Comparative Example 4, exhibited relatively uniform lithium desorption. Example 1, however, exhibited the most uniform electrodeposition-desorption, and had a relatively dense lithium layer uniformly electrodeposited at the bottom.

Although some illustrative embodiments of the present invention have been described above, the disclosure and appended claims are in no way limited by that description. Various modifications may be made within the scope of the claims, the detailed description, and the attached drawings, as well as equivalents thereof, all of which fall within the scope of the present technology.

What is claimed is:

1. An electrolyte for a lithium metal battery, comprising
a lithium salt;
a non-aqueous organic solvent; and
a nitrate additive distinct from the lithium salt;
the lithium salt is included in an amount of greater than or equal to 15 mol % based on a total amount (100 mol %) of the electrolyte for the lithium metal battery, and
the nitrate additive is included in an amount of greater than or equal to 3 mol % based on a total amount (100 mol %) of the electrolyte for the lithium metal battery.

2. The electrolyte of claim 1, wherein the lithium metal battery is a lithium iron phosphate battery.

3. The electrolyte of claim 1, wherein the electrolyte for the lithium metal battery comprises, based on a total amount (100 mol %) of the electrolyte for the lithium metal battery,
15 mol % to 30 mol % of the lithium salt;
3 mol % to 10 mol % of the nitrate additive; and
a balance amount to 100 mol % comprising the non-aqueous organic solvent.

4. The electrolyte of claim 3, wherein the non-aqueous organic solvent is included in an amount of 60 mol % to 80 mol % based on a total amount (100 mol %) of the electrolyte for the lithium metal battery.

5. The electrolyte of claim 1, wherein the non-aqueous organic solvent comprises dipropyl ether, diethyl ether, 1,2-dimethoxyethane, 1,2-diethoxyethane, cyclopentyl methyl ether, methyl propyl ether, n-butyl methyl ether, ethyl propyl ether, dimethoxymethane, 1,4-dioxane, 1,2,2-tetrafluoroethyl-2,2,3,3-tetrafluoropropyl ether, or a combination thereof.

6. The electrolyte of claim 1, wherein the lithium salt comprises at least one of lithium bis(fluorosulfonyl)imide (LiFSI), lithium (fluorosulfonyl)(nonafluorobutanesulfonyl)imide (LiFNFSI), lithium bis(perfluoroethylsulfonyl)imide (LiBETI), and lithium bis(trifluoromethanesulfonyl)imide (LiTFSI).

7. The electrolyte of claim 1, wherein the nitrate additive comprises LiNO₃.

8. A lithium metal battery, comprising
a positive electrode;
a lithium metal layer as a negative electrode and facing the positive electrode;
a separator interposed between the positive electrode and the negative electrode; and
the electrolyte for the lithium metal battery according to claim 1.

9. The lithium metal battery of claim 8, wherein the lithium metal layer comprises a thickness of 5 μm to 200 μm.

10. The lithium metal battery of claim 8, wherein the positive electrode comprises lithium iron phosphate.
